(19) United States
(12) Patent Application Publication
(10) Pub. No.: US 2007/0183285 A1
(43) Pub. Date: Aug. 9, 2007

(54) Optical disk apparatus and recording parameters setting method

(76) Inventors: Koichiro Nishimura, Yokohama (JP); Toru Kawashima, Mito (JP); Tsuyoshi Toda, Kodaira (JP); Atsushi Yamada, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/524,272

(22) Filed: Sep. 21, 2006

(30) Foreign Application Priority Data
Feb. 8, 2006 (JP) JP 2006-031053

(51) Int. Cl. G11B 7/12; G11B 20/14

(52) U.S. Cl. 369/47.53; 369/59.2

(57) ABSTRACT

An optical disk apparatus and a recording parameters setting method are provided to more effectively execute recording parameter learning during data recording on the optical disk, thereby shortening the time required for setting an optimum recording parameter. A phase error detection unit detects a phase error amount from a reproduction signal of actual data being recorded. A phase error adjustment unit adjusts recording parameters (recording strategy) set by a recording parameters setting unit based on the detected phase error amount. The phase error amount detection is executed simultaneously with a verify process of the actual data. If a verify process judgment results says that a target quality is not attained, test writing by a test signal is not executed but the adjustment of recording parameters is conducted on the basis of the phase error amount.

### CLAIM OF PRIORITY

The present application claims priority from Japanese application serial no. JP 2006-031053, filed on Feb. 8, 2006 the content of which is hereby incorporated by reference into this application.

### BACKGROUND OF THE INVENTION

(1) Field of the Invention

The present invention relates to an optical disk apparatus recording data on an optical disk and recording parameters setting method, more specifically, to a technology for executing an efficient setting process of recording parameters.

(2) Description of the Related Art

An optical disk apparatus executes the adjustment of recording parameters by calculating proper laser power and irradiation timing for properties of a given optical disk or disk usage environment during disk loading or right before initiating data recording by radiating a laser beam onto the optical disk. That is, the optical disk apparatus executes test writing with a test signal whose laser power or irradiation timing is varied stepwise in a test writing area on the disk, reproduces the test signal, evaluates quality of the test signal, for example, β (asymmetry), and finally sets optimum recording parameters. Hereinafter, optimization process of recording parameters at the time of data recording will be referred to as recording parameter learning.

In recording parameter learning, plural recording patterns under various recording parameters are recorded in order to derive an optimum recording parameter, so it requires a great deal of time. Japanese Patent Laid-Open Publication No. 2003-30837, for example, discloses a method for evaluating a test signal by detecting a phase error of a reproduction signal and carrying out the adjustment of recording parameters based on the phase error data to reduce the number of test writing.

### SUMMARY OF THE INVENTION

According to the technology described in Japanese Patent Laid-Open Publication No. 2003-30837, test signal quality can be evaluated very efficiently. However, it is not different from other conventional technologies because a specific test signal in a specific test writing area is still used for test writing. For instance, in the case of a DVD-RAM disk, because a region exclusive for test writing is provided around an inner peripheral side and an outer peripheral side of the data recording region of the disk, a pickup needs to move towards a corresponding region during test writing, spending time unnecessarily. In addition, the test writing is repeatedly executed regardless of the limited size test writing region. Resultantly, a corresponding zone is consumed very fast and an optimum recording parameter may not be derived accurately.

It is, therefore, an object of the present invention is to reduce the time required for setting an optimum recording parameter, by carrying out a recording parameter learning more efficiently.

In order to solve the above-mentioned problem, there is provided an optical disk apparatus capable of adjusting recording parameters of a laser beam when recording data by irradiation of a laser beam onto an optical disk, the apparatus including: a spindle motor which rotates the optical disk; a pickup which irradiates the laser beam onto the optical disk and records and reproduces the data; a signal processing unit which generates a record signal of the data, supplies the signal to the pickup, and generates a reproduction signal of the data from a detection signal of the pickup; a recording parameters setting unit which sets the recording parameters when the pickup records the data; a recording quality judgment unit which judges recording quality from the reproduction signal generated by the signal processing unit; a phase error detection unit which detects a phase error amount from the reproduction signal generated by the signal processing unit; a phase error adjustment unit which adjusts the recording parameter set by the recording parameters setting unit on the basis of the phase error amount detected by the phase error detection unit; a memory which stores the recording parameter set by the recording parameters setting unit when the data is recorded; and a control unit which controls the data recording and reproducing operations and the recording parameter setting operation. When the memory already stores recording parameters, the control unit does not execute test writing but initially sets a recording parameter referring to the stored recording parameter, records the data in predetermined unit in a data recording region on the optical disk, reproduces the recorded data to judge recording quality thereof with the recording quality judgment unit and simultaneously executes detection of a phase error amount with the phase error detection unit. Further, the control unit adjusts the recording parameter by the phase error adjustment unit based on the phase error amount detected by the phase error detection unit if a judgment result of the recording quality judgment unit verifies that a target quality is not satisfied.

Preferably, the phase error detection unit combines a mark length and a space length included in the data, respectively, and measures a shift amount of a mark edge position per pattern. In addition, the phase error adjustment unit adjusts for each of the patterns a power level or an irradiation timing of the laser beam set by the recording parameters setting unit, so as to compensate the measured shift amount.

Another aspect of the present invention provides a recording parameters setting method during data recording by irradiation of a laser beam onto an optical disk, the method including the steps of: storing a recording parameter set during the data recording in a memory or in a predetermined area of the corresponding optical disk; if the memory or the optical disk already stores recording parameters, not executing a test writing process but initially setting a recording parameter referring to the stored recording parameters, recording the data in predetermined unit in a data recording region on the optical disk, reproducing the data, and conducting a recording quality judgment process judging recording quality from the reproduction signal obtained by reproducing the recorded data, and detecting a phase error amount from the reproduction signal simultaneously with the recording quality judgment process. If target quality is not attained according to a recording quality measurement result, adjusting recording parameters of the laser beam for use in recording the data, on the basis of the detected phase error amount.

In addition, test writing process is executed, through which test signals under various recording parameters are recorded in a test writing region on the optical disk and the recorded test signals are reproduced so as to obtain an optimum recoding parameter; and a recording parameter is initially set by executing the test writing process when new data is to be recorded.

Moreover, recording parameters set during data recording are stored in a memory or a predetermined area on the optical disk, and the recording parameter is initially set when new data needs to be recorded by referring to the stored recording parameters in the memory or the optical disk.

### BRIEF DESCRIPTION OF THE DRAWINGS

FIG. 1 is a block diagram showing an optical disk apparatus according to one embodiment of the present invention;

FIG. 2 is a diagram explaining the operations of a phase error detection unit and a phase error adjustment unit in FIG. 1;

FIGS. 3A to 3C illustrate an example of a table listing phase error measurement results and recording strategy adjustment;

FIG. 4 is a flowchart describing an example of data recording according to a conventional recording parameters setting method; and

FIG. 5 is a flowchart explaining an embodiment of data

FIG. 5 is a flowchart explaining an embodiment of data recording according to a recording parameters setting method of the present invention.

### DETAILED DESCRIPTION OF THE PREFERRED EMBODIMENTS

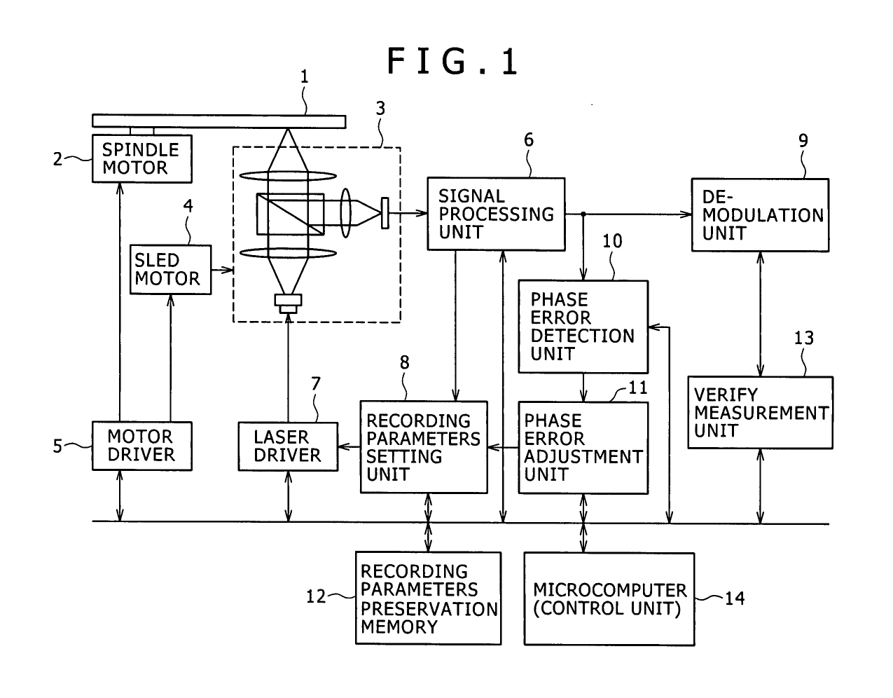

FIG. 1 is a block diagram showing an optical disk apparatus according to one embodiment of the present invention. The apparatus of this embodiment rotates an optical disk 1 with a spindle motor 2. A pickup 3 irradiates a laser beam emitted from a semiconductor laser onto a recording surface of the optical disk 1, records/reproduces data or a test writing test signal and detects a reflected light from the optical disk 1. At this time, a data recording region of the optical disk 1 is used for recording/reproducing the data, and a test writing region is used for recording/reproducing the test signal. The pickup 3 includes a built-in objective lens and an actuator for adjusting the position of the objective lens, taking part in adjustment of focus and tracking. A sled motor 4 moves the pickup 3 in a radial direction on the optical disk. A motor driver 5 provides a drive signal for driving the spindle motor 2, the sled motor 4 or the actuator.

A signal processing unit 6 generates a record signal to be recorded on the optical disk 1 and provides it to the pickup 3 with a laser driver 7 interposed. At this time, a recording parameters setting unit 8 sets recording parameters of a laser etc. Hereinafter it will be referred to as a recording strategy) to form a desired mark and space, and drives the laser driver 7. In addition, if necessary to obtain an optimum recording parameter, the recording parameters setting unit 8 may carry out a test writing process using a test signal.

Meanwhile, the signal processing unit 6 processes an output signal from the pickup 3 and generates an RF signal, a focus error signal FE, a tracking error signal TE and the like. The RF signal is demodulated by a demodulation unit 9 and becomes data to be reproduced. A focus servo signal and a tracking servo signal are generated from the FE signal and the TE signal, respectively, and are sent to the motor driver 5.

The apparatus of this embodiment also includes a phase error detection unit 10 detecting a phase error amount from a reproduction signal of data recording on a data recording region. To this end, a shift amount at an edge position of a mark and of a space formed separately for each pattern (combination of a mark length and a space length) included in the reproduction signal is analyzed. This function is called a TIA (Time Interval Analyzer) function. A phase error usually causes an error in data reproducing, leading to deterioration in the recording quality. To resolve this problem on the basis of a detected phase error amount, a phase error adjustment unit 11 adjusts the recording parameters (recording strategy) set by the recording parameters setting unit 8. With help of the phase error detection unit 10 and the phase error adjustment unit 11, it becomes possible to adjust recording parameters using actual data and to omit a conventional test writing process by a test signal.

Moreover, the apparatus of the present invention has a so-called verify function judging or verifying the recording quality after data is recorded. Therefore, the apparatus records data the in data recording region on the optical disk 1 in predetermined unit (verify unit) and reproduces the recorded data per predetermined unit. Then, a verify measurement unit 13 measures quality (e.g., an error amount) of the data thusly reproduced, and a microcomputer 14 judges whether a target quality can be attained. If the measured quality equates to the target quality, the present recording parameter is retained. However, if the target quality is not attained, the phase error adjustment unit 11 executes the adjustment of recording parameters on the basis of the phase error amount detected by the phase error detection unit 10.

After data is recorded, the recording parameters setting unit 8 stores in a recording parameter preservation memory 12 the recording parameters set during the data recording operation. Here, an optimum parameter for each disk is stored. By referring to the information stored in the recording parameter preservation memory 12, an initial setting of recording parameters for subsequent recording can be done promptly.

The microcomputer (control unit) 14 executes a control operation on the apparatus overall and, at the same time, verifies a series of operations of the apparatus, i.e., recording parameter setting, recording and reproducing and executes the control operation. In addition, the optical disk apparatus of the present embodiment is connected to an external host device (such as, a personal computer) (not shown) and transmits data to be recorded/reproduced through interface and transmits/receives a command.

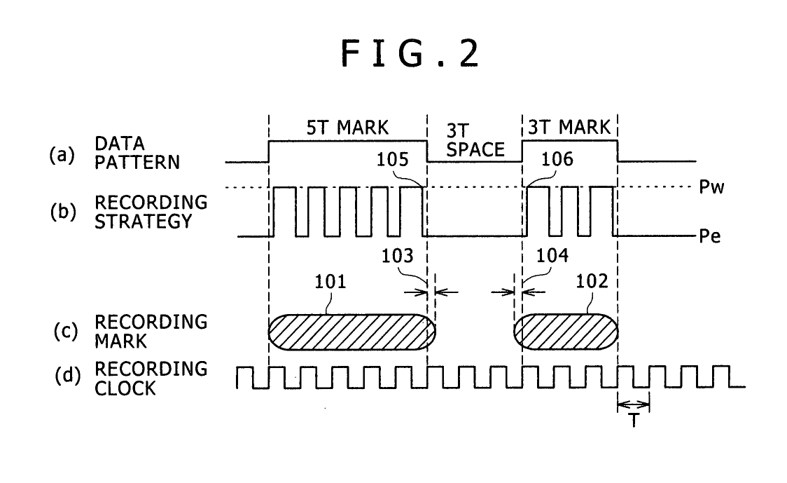

FIG. 2 is a diagram explaining the operations of the phase error detection unit 10 and the phase error adjustment unit 11 in FIG. 1. In detail, FIG. 2(a) illustrates an example of a recording data pattern followed by 5T mark, 3T space, 3T mark, etc. FIG. 2(b) illustrates a recording strategy (laser irradiation pulse waveform) thereof. FIG. 2(c) illustrates a configuration of a recording mark formed on the optical disk recording film. Lastly, FIG. 2(d) illustrates a recording clock signal (period T).

The phase error detection unit 10 analyzes a reproduction signal waveform of actual data and measures a shift amount from recording clock signals at a leading edge and a trailing edge of recording marks 101 and 102. In the drawing, a shift amount 103 at the trailing edge of the mark 101 and a shift amount 104 at the leading edge of the mark 102 are detected.

The phase error adjustment unit 11 adjusts timing of the recording strategy to resolve the shift amount (phase error amount) of the mark edge detected by the phase error detection unit 10. In the drawing, the timing is adjusted to make a trailing edge 105 of an irradiated pulse at an earlier timing with respect to the mark shift amount 103, while a leading edge 106 of the irradiated pulse at a later timing with respect to the mark shift amount 104.

An actually recorded data includes randomly distributed components from 3T to 14T for mark length and space length. Thanks to the TIA function of the phase error detection unit 10, it is possible to adjust the recording strategy of each pattern by measuring a phase error amount per combination pattern of the mark length and the space length.

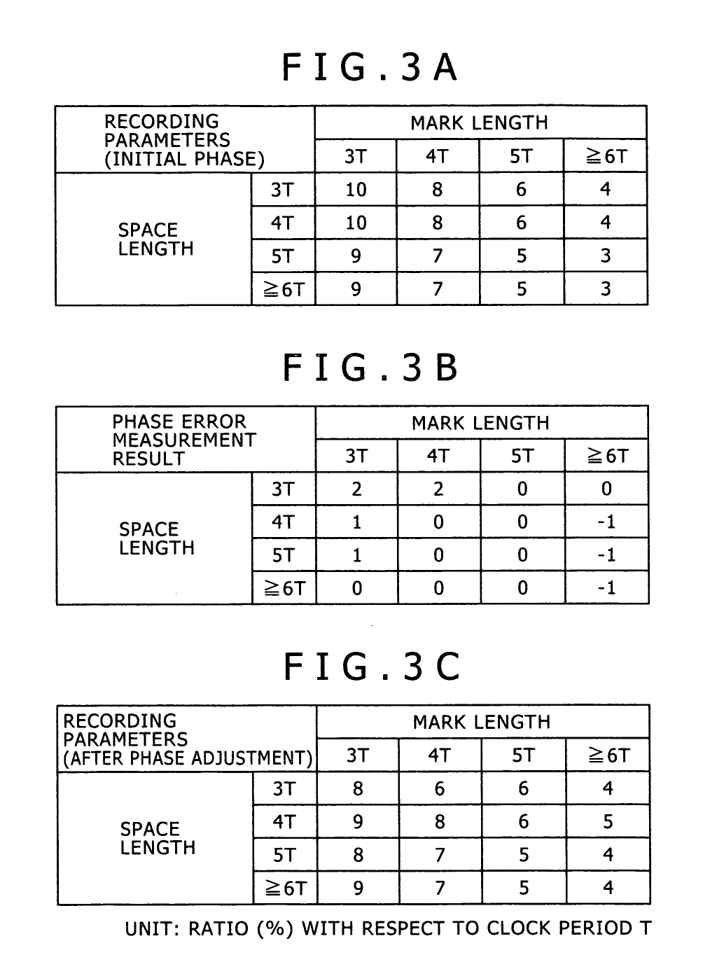

FIGS. 3A to 3C illustrate an example of a table listing phase error measurement results and recording strategy adjustment. In detail, FIG. 3A illustrates recording strategy parameters (initial phase) for actual data recording, FIG. 3B illustrates phase error amounts measured during an actual data reproduction, and FIG. 3C illustrates recording strategy parameters (after phase adjustment) adjusted depending on the phase error amounts. Here, mark lengths (space lengths) for a leading edge are distributed in respective combination patterns greater than 3T, 4T, 5T and 6T (it yields almost the same result for 6T to 14T). Here, phase errors are expressed in unit of ratios (%) with respect to clock periods T.

For example, in a pattern of 3T mark/3T space with 10% initial phase, a phase error measurement is 2%. To compensate this phase error, the phase of a recording parameter is adjusted to 8%, as shown in FIGS. 3A to 3C.

Even though FIG. 2 and FIGS. 3A to 3C mainly explained about the irradiation timing adjustment of a laser irradiating pulse among the recording strategy, laser power can also be adjusted in similar manner. To this end, a relationship between phase errors being detected and adjusted amounts of laser power is preferably set in advance for adjustment.

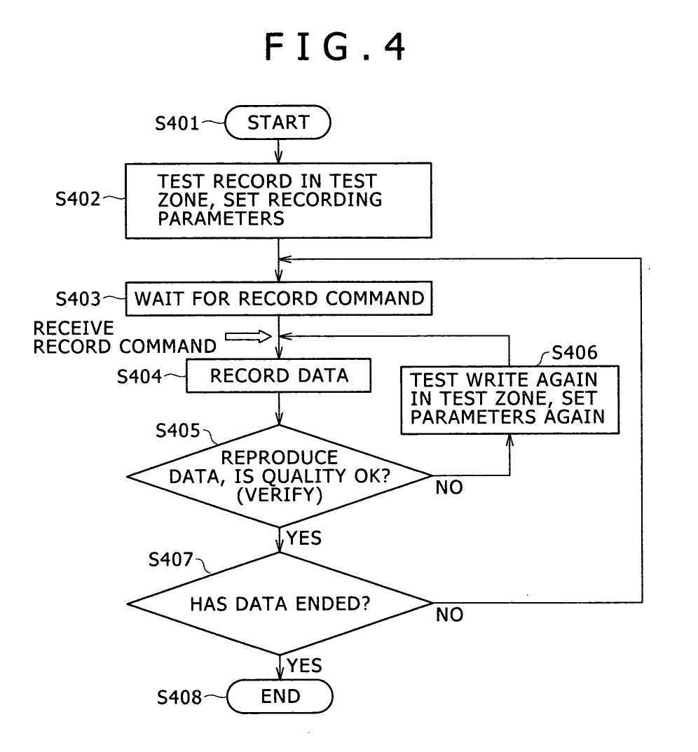

FIG. 4 is a flowchart describing an example of data recording following a conventional recording parameters setting method which is provided for comparison.

According to the conventional method, an optical disk (for example, a DVD-RAM) is loaded and test writing is first conducted using a test writing area (drive test zone) before actually recording data on the disk. The drive test zone is located on the inner peripheral side and an outer peripheral side of the disk, and a specific test signal under the recording parameter (laser power or irradiation timing) stepwisely modified is recorded in this zone. Next, the recorded test signal is reproduced and its quality (e.g., asymmetry) is evaluated in order to derive an optimum recording parameter. The recording parameter thus derived is set to an initial parameter of the optical disk (S402). In this manner, the optical disk apparatus enters standby mode (ready state) to be able to receive a record command from a host device (e.g., a personal computer) (S403).

Upon receiving the record command from the host device, the apparatus records data in a designated address. The data is recorded in unit of recording quality verifying operation (verify operation) that follows (S404). After recording the data, the apparatus reproduces the recorded data and checks its quality. For instance, whether the recording operation is defective is judged by an error amount being detected (verify judgment) (S405).

If the verify judgment result says that the recording quality does not satisfy target quality, test writing is conducted again in the drive test zone and an optimum recording parameter is adjusted and set accordingly one more time (S406). Then, data is recorded again, going back to the step S404. On the other hand, if the verify judgment result says that the recording quality equates to the target quality, the present recording parameter is retained and whether or not the data recording operation has been ended is judged (S407). If so, the apparatus ends the recording operation (S408). If not, the apparatus reenters standby mode (S403), waiting for a subsequent record command.

As described above, the conventional recording parameters setting method includes the test writing process (S402) during loading and the test writing process based on the verify judgment result (S406). Hence, the frequency of test writing operations was high, spending much time therefor. In addition, since the test writing is carried out using the drive test zone every time, additional time for the pickup to move between the drive test zone and the user data recording area should be granted, leading to time loss. Moreover, because the drive test zone has a limited size, repeating test writing operations resultantly consumes the zone fast, making it difficult to derive an optimum recording parameter accurately.

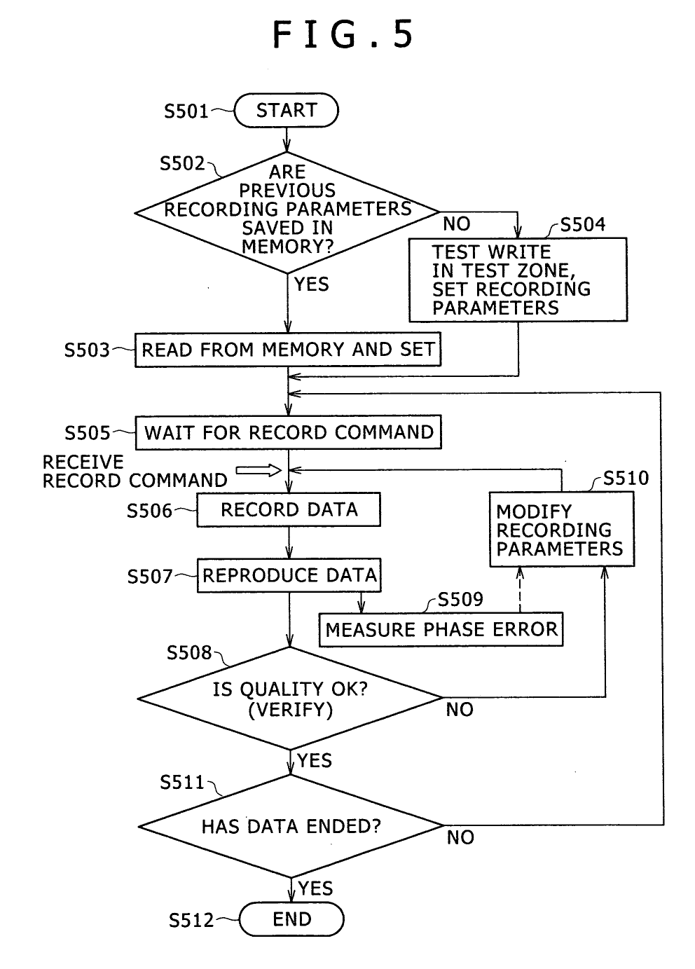

FIG. 5 is a flowchart explaining an embodiment of data recording following a recording parameters setting method of the present invention. In this embodiment, the optical disk apparatus takes advantage of its TIA function to analyze a phase error in actual data being recorded and therefore, to adjust a recording parameter.

When an optical disk is loaded, it is examined that the previously set recording parameters on the disk is well stored in the recording parameter preservation memory 12. This can be done by checking the disk ID for example. If the parameters are already stored in the memory, the stored parameters are read out for use in an initial setting (S503). The apparatus enters standby mode (ready state) to be able to receive a record command from a host device (S505).

However, if the previous recording parameters are not stored in the memory, test writing is executed, as in the step S402 of FIG. 4, in a test writing region (drive test zone) and derives an optimum recording parameter to set the recording parameter (S504). And, the apparatus enters standby mode in ready state (S505).

When a record command is received from a host device, the apparatus records data in a designated address in verify operation unit (S506). After recording the data, the apparatus reproduces the recorded data (S507) and judges the recording quality (e.g., error amount) (verify judgment) (S508).

Simultaneously with the verify judgment in step S508, a phase error amount of a reproduced waveform is measured using the TIA function of the phase error detection unit 10. By analyzing the reproduced waveform of an actual data, the phase error detection unit 10 measures a phase error amount per combination pattern of a mark length and a space length or a leading edge and a trailing edge (S509).

If the verify judgment result in step S508 says that the recording quality failed to meet the target quality, the phase error adjustment unit 11 modifies and sets the recording parameter for each pattern based on the phase error information acquired in step S509 (S510). Then, the apparatus records the data again, going back to the step S506.

In the meantime, if the verify judgment result in step S508 says that the recording quality satisfies the target quality, the present recording parameter is retained and the apparatus judges whether or not the data recording operation has been ended (S511). If so, the apparatus ends the recording operation (S512). If not, the apparatus reenters standby mode (S505), waiting for a subsequent record command.

According to the recording parameters setting method of the present embodiment, test writing is executed (S504) during loading only if the previous recording parameters are not stored in the memory. Therefore, the present method can reduce the frequency of the test writing process. Moreover, the test writing process based on the verify judgment result (S406 in the conventional method) is omitted, and the recording parameter adjustment is executed based on the phase error amount acquired simultaneously with the verify process.

As the number of test writing process being done is substantially reduced, the time taken to start data recording can be shortened. Moreover, what is evaluated in the adjustment of recording parameters with the TIA function is the actual data and the drive test zone for test writing is not used at all. In other words, unlike the conventional method, the pickup does not need to move to the drive test zone too often for test writing, and therefore unnecessary time loss does not occur. In addition, by reducing the excessive consumption of the drive test zone by frequent test writing processes and, at the same time, by making the evaluation for adjustment of recording parameters at the actual data recording position, reliability of deriving an optimum recording parameter can be improved.

Although in this embodiment the verify operation involved the recording quality after data recording, it is not limited thereto. For instance, according to another simple and easy method for judging the recording quality, every time a certain amount of data is recorded, the end portion of the recorded data is reproduced and jitter property thereof can be evaluated with the TIA function (that is, before demodulation). The above-described recording parameter adjustment with the TIA function equally and effectively applied to this method.

In addition, although in this embodiment the initial setting of the recording parameter is carried out in absence of the test writing process by reading out the previous recording parameters during loading out of the recording parameter preservation memory built in the apparatus, the previous recording parameters can also be saved in the disk itself, not the memory, for use in the initial setting of the recording parameter. In the case of the DVD-RAM for example, after data is recorded, the recording parameter set for data recording is stored in a designated area of the disk such as the DIZ (Disk Identification Zone) where the optical disk ID information is recorded. In this manner, the initial setting of the recording parameter for a subsequent recording operation can be done promptly.

In general, optical disks being shipped usually bear information of recommended recording parameters provided by disk manufacturers. Therefore, by referring to those recording parameters registered to a corresponding disk at the time of loading, the apparatus does not need to execute test writing but directly initiates setting of the recording parameter.

Although in this embodiment the DVD-RAM is explained as the optical disk, the present invention is not limited thereto. For example, the present invention can effectively applied to optical disks with much greater storage capacities like a DVD-RW or Blu-ray disk format.

According to the present invention, the time required for setting a recording parameter can be shortened, whereby a recording operation can be started promptly.

What is claimed is:

1. An optical disk apparatus capable of adjusting recording parameters of a laser beam when recording data by irradiation of a laser beam onto an optical disk, the apparatus comprising:
a spindle motor which rotates the optical disk;
a pickup which irradiates the laser beam onto the optical disk and records and reproduces the data;
a signal processing unit which generates a record signal of the data, supplies the signal to the pickup, and generates a reproduction signal of the data from a detection signal of the pickup;
a recording parameters setting unit which sets the recording parameters when the pickup records the data;
a recording quality judgment unit which judges recording quality from the reproduction signal generated by the signal processing unit;
a phase error detection unit which detects a phase error amount from the reproduction signal generated by the signal processing unit;
a phase error adjustment unit which adjusts the recording parameter set by the recording parameters setting unit on the basis of the phase error amount detected by the phase error detection unit;
a memory which stores the recording parameter set by the recording parameters setting unit when the data is recorded; and
a control unit which controls the data recording and reproducing operations and the recording parameter setting operation,
wherein, when the memory already stores recording parameters, the control unit does not execute test writing but initially sets a recording parameter referring to the stored recording parameter, records the data in predetermined unit in a data recording region on the optical disk, reproduces the recorded data to judge recording quality thereof with the recording quality judgment unit and simultaneously, executes detection of a phase error amount with the phase error detection unit, and adjusts the recording parameter by the phase error adjustment unit based on the phase error amount detected by the phase error detection unit if a judgment result of the recording quality judgment unit verifies that a target quality is not satisfied.

2. The optical disk apparatus according to claim 1, wherein the control unit records the data in predetermined unit and reproduces the recorded data in the predetermined unit, and executes a verify process judging the quality of a reproduction signal by recording quality judgment unit.

3. The optical disk apparatus according to claim 1, wherein the recording parameters setting unit executes a test writing process, through which test signals under various recording parameters are recorded in a test writing region on the optical disk and the recorded test signals are reproduced so as to obtain an optimum signal parameter;
wherein, the control unit initially sets a recording parameter by executing the test writing process with the recording parameters setting unit when a new data is to be recorded, and
the control unit does not execute the test writing process but executes adjustment of the recording parameter by the phase error adjustment unit based on the phase error amount detected by the phase error detection unit, in the case that the data recording quality is not equated to the target quality according to the judgment result provided from the recording quality judgment unit.

4. The optical disk apparatus according to claim 1, wherein the phase error detection unit combines a mark length and a space length included in the data, respectively, and measures a shift amount of a mark edge position per pattern; and
the phase error adjustment unit adjusts for each of the patterns a power level or an irradiation timing of the laser beam set by the recording parameters setting unit, so as to compensate the measured shift amount.

5. A recording parameters setting method during data recording by irradiation of a laser beam onto an optical disk, the method comprising the steps of:
storing a recording parameter set during the data recording in a memory or in a predetermined area of the corresponding optical disk;
if the memory or the optical disk already stores recording parameters, not executing a test writing process but initially setting a recording parameter referring to the stored recording parameters, and reproducing the data which is recorded in the data recording region on the optical disk;
detecting a phase error amount from a reproduction signal obtained by reproducing the data; and
adjusting recording parameters of the laser beam for use in recording the data, on the basis of the detected phase error amount.

6. A recording parameters setting method during data recording by irradiation of a laser beam onto an optical disk, the method comprising the steps of:
storing a recording parameter set during the data recording in a memory or in a predetermined area of the corresponding optical disk;
if the memory or the optical disk already stores recording parameters, not executing a test writing process but initially setting a recording parameter referring to the stored recording parameters, recording the data in predetermined unit in a data recording region on the optical disk, reproducing the data, and conducting a recording quality judgment process judging recording quality from the reproduction signal obtained by reproducing the recorded data;
detecting a phase error amount from the reproduction signal simultaneously with the recording quality judgment process; and
if target quality is not attained according to a recording quality measurement result, adjusting recording parameters of the laser beam for use in recording the data, on the basis of the detected phase error amount.

7. The recording parameters setting method according to claim 6, wherein the recording quality judgment process is a verify process which records the data in predetermined unit, reproduces the recorded data per predetermined unit, and judges the quality of a reproduction signal per predetermined unit.

8. The recording parameters setting method according to claim 6, wherein a test writing process is executed, through which test signals under various recording parameters are recorded in a test writing region on the optical disk and the recorded test signals are reproduced so as to obtain an optimum signal parameter;
wherein a recording parameter is initially set by executing the test writing process when a new data is to be recorded, and
the test writing process is not executed but adjustment of the recording parameter is executed based on the phase error amount detected, in the case that the data recording quality is not equated to the target quality according to a judgment result provided from the recording quality judgment process.

9. The recording parameters setting method according to claim 6,
wherein, in the phase error detection process, a mark length and a space length included in the data are combined, respectively, and a shift amount of a mark edge position is measured per pattern; and
in the recording parameter adjustment process, a power level or an irradiation timing of the laser beam at the time of recording is adjusted for each of the patterns, so as to compensate the measured shift amount.
